(19) United States
(12) Patent Application Publication
(10) Pub. No.: US 2026/0358019 A1
(43) Pub. Date: Nov. 12, 2026

(54) HYBRID HEATING SYSTEM FOR POTABLE HOT WATER AND METHOD

(71) Applicant: TOROMONT INDUSTRIES LTD., Concord (CA)

(72) Inventors: Joshua BELL, Innisfil (CA); David FAUSER, Toronto (CA); Wayne BORROWMAN, Scarborough (CA)

(21) Appl. No.: 19/671,747

(22) Filed: May 8, 2026

Related U.S. Application Data
(60) Provisional application No. 63/802,985, filed on May 9, 2025.

(51) Int. Cl. F24H 1/00; F24H 1/18; F24S 10/30; F24S 20/40; F24S 21/00; F24S 80/00; H02S 40/44

(52) U.S. Cl. CPC F24H 1/0072; F24H 1/185; F24S 10/30; F24S 20/40; F24S 21/00; F24S 80/00; H02S 40/44; F24H 2240/09

(57) ABSTRACT

A heating system for potable water tank in conjunction with a main refrigeration circuit. The heating system may have a heat exchanger configured to be in a heat exchange relation with potable water in the potable water tank, the heat exchanger configured to receive therein a refrigerant or coolant in condition for heating the potable water as the refrigerant or coolant is associated with an exit of at least one compressor of the main refrigeration circuit. At least one solar heating system is configured for generating heat from solar power, the at least one heating system using the heat generated from solar power to heat the potable water in the potable water tank. A controller unit is configured for operating the heating system as a function of at least one parameter associated with energy characterization.

### CROSS-REFERENCE TO RELATED APPLICATION

The present application claims the priority of United States Patent Application No. 63/802,985, filed on May 9, 2025, the content of which is incorporated herein by reference.

### FIELD OF THE APPLICATION

The present application relates to refrigeration systems used in industrial refrigeration applications and to efficient uses thereof, including reclaim of heat.

### BACKGROUND OF THE ART

Industrial-size refrigeration systems are used in numerous applications. For example, supermarkets, large-scale buildings, multiplex buildings, sporting facilities, industrial cooling facilities, commercial facilities, food processing facilities, are among the numerous instances in which central refrigeration systems are used. The central refrigeration systems may be used for refrigerating foodstuff, for air-conditioning space, for operating freezers, and/or for maintaining ice-playing surfaces (also known as ice sheets), with some of these functionalities combined when required by the facilities.

In such industrial-size refrigeration systems, the condensing stage must release substantial amounts of heat from compressed refrigerant, as part of the thermodynamic cycle, to enable the refrigerant to absorb heat in refrigeration duties. As global climate concerns have driven requirements for more efficient energy consumption and/or for green energies (e.g., having relatively limited carbon footprint), refrigeration system may be regarded as being inefficient due to the amount of heat that is exhausted to the environment.

Technologies have therefore been developed to reclaim the heat in the condensing stage. Such technologies have been used in parallel with green energy sources. However, in some instances, some efficiency gains may still be made in spite of the presence and use of various green energy sources and reclaim, especially in contexts in which multiple energy sources are available.

### SUMMARY OF THE APPLICATION

It is therefore an aim of the present disclosure to provide a refrigeration system that addresses issues associated with the prior art.

In a first aspect, there is provided a heating system for potable water tank in conjunction with a main refrigeration circuit, the heating system comprising: a heat exchanger configured to be in a heat exchange relation with potable water in the potable water tank, the heat exchanger configured to receive therein a refrigerant or coolant in condition for heating the potable water as the refrigerant or coolant is associated with an exit of at least one compressor of the main refrigeration circuit; at least one solar heating system configured for generating heat from solar power, the at least one solar heating system using the heat generated from solar power to heat the potable water in the potable water tank; and a controller unit configured for operating the heating system as a function of at least one parameter associated with energy characterization.

Still further in accordance with the first aspect, for instance, the at least one solar heating system is a solar thermal system configured to generate heat from solar power and/or a solar photovoltaic system configured to convert solar power into electric power.

Still further in accordance with the first aspect, for instance, the solar thermal system includes a network of piping configured to cycle a coolant between at least one solar thermal panel and a coil in heat exchange relation with the potable water of the potable water tank.

Still further in accordance with the first aspect, for instance, the network of piping includes a pump.

Still further in accordance with the first aspect, for instance, the solar heating system includes both the solar thermal system and the solar photovoltaic system, and wherein the pump is operated by electric power generated by the solar photovoltaic system.

Still further in accordance with the first aspect, for instance, the heating system may include both the solar thermal system and the solar photovoltaic system, and wherein the solar photovoltaic system includes a circuit featuring a battery to store electric power generated by at least one photovoltaic panel of the solar photovoltaic system.

Still further in accordance with the first aspect, for instance, the heating system may include both the solar thermal system and the solar photovoltaic system, and including at least one hybrid solar panel configured to generate heat and electric power.

Still further in accordance with the first aspect, for instance, the solar thermal system includes an electric heater, and wherein the electric heater is configured to be selectively powered by the grid.

Still further in accordance with the first aspect, for instance, the heat exchanger is a desuperheater heat exchanger.

Still further in accordance with the first aspect, for instance, the heat exchanger is a gas cooling heat exchanger.

Still further in accordance with the first aspect, for instance, the solar thermal system includes an electric heater, and wherein the electric heater is configured to be selectively powered by the grid.

Still further in accordance with the first aspect, for instance, the heating system may include at least one other system for heating the water.

Still further in accordance with the first aspect, for instance, the other system includes an electric coil configured to be powered by the grid.

Still further in accordance with the first aspect, for instance, the other system includes a fossil fuel heated coil configured to provide heat by fossil fuel combustion.

Still further in accordance with the first aspect, for instance, the other system includes a heat pump system configured to heat a refrigerant of the main refrigeration system between the at least one compressor of the main refrigeration circuit and the heat exchanger of the heating system.

In accordance with a second aspect of the present disclosure, there is provided a refrigeration system comprising: a main refrigeration circuit in which a refrigerant circulates at least between a compression stage in which the refrigerant is compressed, a cooling stage in which the compressed refrigerant releases heat, and a refrigeration stage in which the refrigerant absorbs heat to then be directed at least partially to the compression stage; and the heating system according to the first aspect.

Still further in accordance with the second aspect, for instance, the refrigeration system is a supermarket refrigeration system or an ice-rink refrigeration system.

In accordance with a third aspect of the present disclosure, there is provided a system for heating potable hot water, comprising: a processing unit; and a non-transitory computer-readable memory communicatively coupled to the processing unit and comprising computer-readable program instructions executable by the processing unit for: operating a main refrigeration circuit as a function of a cooling load of an evaporation stage, the main refrigeration circuit using a refrigerant; harvesting energy from solar power; monitoring at least one parameter associated with energy characterization; and as a function of a heating demand of potable hot water tank, selectively: directing at least a portion of said refrigerant from a compressor of the main refrigeration circuit to a heating system for heating potable water in the potable hot water tank, and generating heat from the solar power to heat potable water in the potable hot water tank.

Still further in accordance with the third aspect, for instance, as a function of the heating demand of potable hot water tank, the system may selectively use the solar power to generate electricity and store the electricity in a battery.

### BRIEF DESCRIPTION OF THE DRAWINGS

FIG. 1 is a block diagram of a refrigeration system with a hybrid heating system for potable hot water in accordance with the present disclosure;

FIG. 2 is a schematic view of a variant of the hybrid heating system for potable hot water of FIG. 1.

### DESCRIPTION OF THE PREFERRED EMBODIMENTS

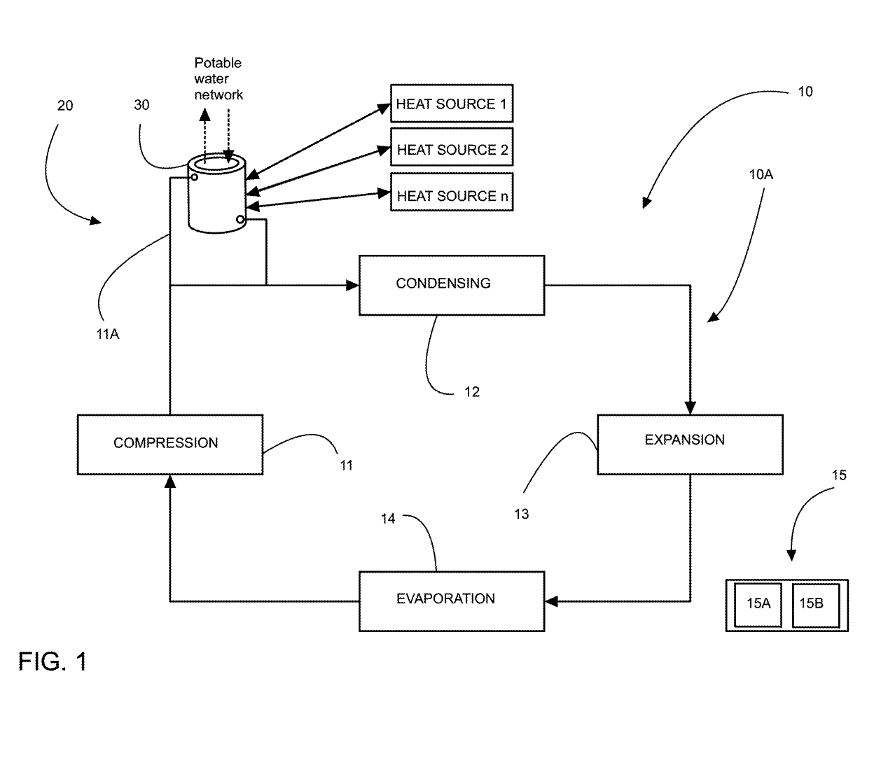

Referring to FIG. 1, a refrigeration system with a hybrid heating system for potable hot water in accordance with the present disclosure is illustrated at 10, and is provided as an example. The refrigeration system 10 may have a conventional refrigeration circuit (referred to as main refrigeration circuit and shown as 10a for reference purposes) featuring a compression stage 11, a condensing stage 12, an expansion stage 13 and/or an evaporation stage 14. A controller unit 15 may be used to centrally control the various components and stages of the refrigeration system 10. The controller unit 15 is the processing unit of the refrigeration system 10, and may have one or more processors 15a. A non-transitory computer-readable memory 15b may be communicatively coupled to the processing unit and may have computer-readable program instructions executable by the processing unit for operating the hybrid heating process described herein. A hybrid heating system for potable hot water is generally shown at 20 in FIG. 1.

Refrigerant enters compressor(s) in the compression stage 11 as a saturated vapor (or other condition) and is compressed to a higher pressure and temperature. In a variant, the compression stage 11 has numerous compressors in parallel and/or cascaded, the compression stage 11 representative as a box in FIG. 1 of a plurality of compressors as a possibility. The compressed refrigerant vapor is then routed to the condensing stage 12 where it is cooled and condensed into a liquid by flowing through a condenser unit(s), in which the refrigerant circulates (e.g., in coils) and is in a heat exchange relation (i.e., no contact, no matter transfer, but heat transfer enabled) with a coolant such as cooling water or cooling air flowing across the coils. The circulating refrigerant hence rejects heat from the refrigeration system, the rejected heat being carried away or removed by either the liquid (e.g., water, glycol) or the air (or like gas coolant) depending on the type of condenser unit used, as described below. The condensing stage 12 may also include desuperheating in instances in which the refrigerant is superheated as a result of the cooling load. Likewise, in some given instances such as when the refrigerant is carbon dioxyde, the condensing stage 12 may also include gas cooling in which the refrigerant in a gaseous state, such as in a supercritical state, is cooled to a lower temperature.

In essence, a condenser unit is where a vapor refrigerant is condensed into a liquid refrigerant. Depending on the type of refrigerant and the pressures, it is also possible that the vapor refrigerant remains at least partially in a vapor condition, and this may be known as gas cooling. Such gas cooling may also be part of the condensing stage 12 even if condensation does not occur or occurs in a minimum fashion.

The condensing stage 12 may also include heat reclaim, that may be used for example by the hybrid heating system 20. In a variant, heat reclaim may be defined by the fact that heat is not released to the outside and wasted. Heat reclaim means that the heat is captured to be used for a given heating purpose. Heat reclaim may also mean that the heating performed with the reclaimed heat is not the primary purpose of the main refrigeration circuit 10a, the primary purpose being to refrigerate. In the present disclosure, heat may be reclaimed to heat water (e.g., potable water) in the hybrid heating system 20, as described below. Moreover, other reclaiming actions may be performed in the main refrigeration system circuit, i.e., reclaiming is not limited to the heating of the potable water in the hybrid heating system 20.

Different types of condenser units may be used as part of the condensing stage 12, with one or more condenser unit in the refrigeration system 10, such as air-cooled condenser units, gas coolers, evaporative condenser units, and water-cooled condenser units. The condensing stage 12 is shown generally, but may have different components in different arrangements, such as heat exchangers used in heat reclaim, in parallel and/or in series with condenser units that reject heat to the environment. The condensing stage 12 may thus also be referred to as a refrigerant cooling stage, heat reclaim stage or heat release stage as heat is released from the refrigerant through stage 12.

The condensing liquid refrigerant may then be accumulated in one or more receivers (not shown). The receiver(s) is one or more storage vessels (i.e., tank, reservoir) in which the refrigerant is stored mostly in a liquid state, with vapour. The condensed liquid refrigerant may next be directed through an expansion stage 13 in which valve(s) of any type, such as expansion valves, causes a reduction in pressure to the refrigerant. Other mechanisms and configurations may also be used, including flooded configurations with a pump or pumps, such that the expansion stage 13 may be optional. The pressure reduction results in a lowering of the temperature of the refrigerant to reach a temperature colder than the temperature of the fluid, space and/or surface to be refrigerated.

The colder refrigerant may then circulate in the coil or tubes of evaporator(s) of the evaporation stage 14, by which the cold refrigerant absorbs heat from a fluid, such as a liquid or a gas depending on the application with which the refrigeration system 10 is used. The evaporation stage 14 is where the refrigerant absorbs and removes heat that is subsequently rejected in the condensing stage 12. The coils of the evaporation stage 14 may be part of refrigerated enclosures, such as in a supermarket, in a slab of an ice sheet(s), in industrial refrigeration coils, etc, all this depending on the contemplated use. As another possibility, the coils of the evaporation stage 14 are part of a heat exchanger, with the refrigerant of the refrigeration system 10 being in heat exchange with a coolant (e.g., glycol, brine). In an embodiment, the coolant circulates in coils of an ice sheet. Other arrangements are considered as well, depending on the contemplated use of the refrigeration system 10.

To complete the refrigeration cycle, the vapor resulting from the evaporation stage 14 is again at least partially in a saturated vapor state and is cycled into the compression stage 11. The circuit portion of the refrigeration system 10 between the compression stage 11 and the expansion stage 13 (including the condensing stage 12 and receiver(s) 13) may be referred to as the high-pressure side as the refrigerant pressure is higher in comparison to a circuit portion of the refrigeration system 10 between the expansion stage 13 and the compression stage 11 (including the evaporation stage 14), itself referred to as the low-pressure side. The demarcation between high-pressure side and low-pressure side may be elsewhere, such as at a pressure regulating valve for transcritical refrigeration or for other purposes, upstream of the expansion stage 13.

The refrigeration system 10 is schematically shown in FIG. 1 as a simplified example of a system capable of operating a refrigeration cycle. However, multiple other features and components may be added to the refrigeration system 10, such as a desuperheater upstream or as part of condensing/rejection stage 12, defrosting, heat reclaiming, receivers, oil systems, fans(s) and/or ventilator(s), pumps, to name but a few, as well as the appropriate piping and valves to ensure that the refrigerant is directly to the various components as desired. Again, the refrigeration system 10 may include a plurality of compressors (e.g., in parallel, cascaded, dedicated), condensers, evaporators, depending on the refrigeration load of the system 10. Moreover, different types of refrigerant may be used, including synthetic fluorocarbon refrigerants and their blends (e.g., HCFC, HFC, HFO and blends thereof), ammonia, CO₂ refrigerant, hydrocarbon refrigerant, etc, for different uses, such as industrial refrigeration (e.g., process refrigeration, industrial cold storage), ice-playing surfaces (a.k.a., ice sheets), supermarket refrigeration, HVAC, among possibilities.

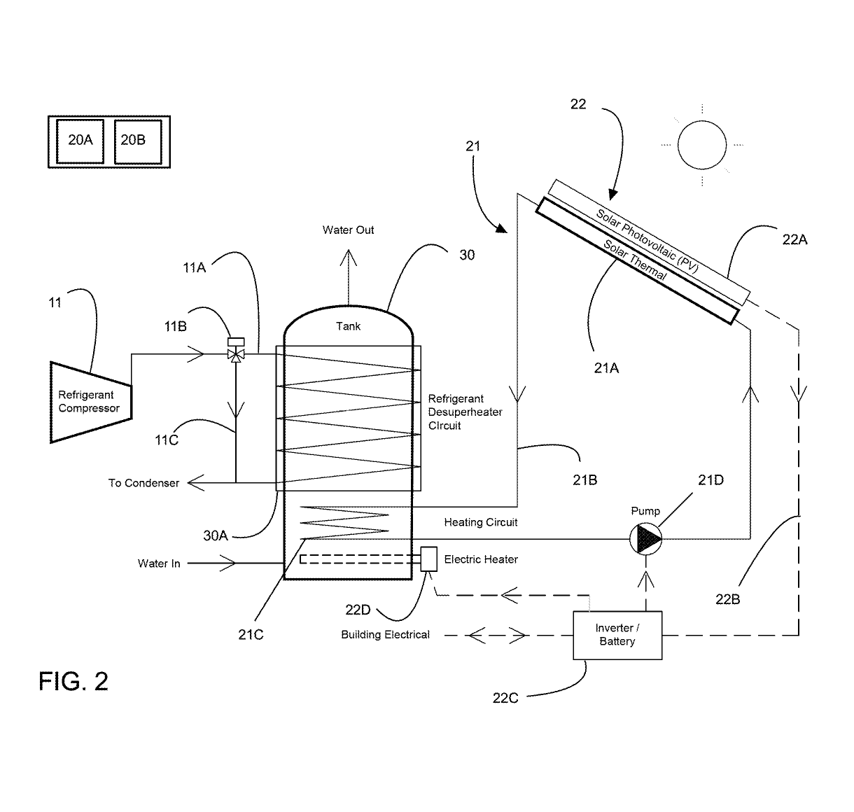

The controller unit 15 may be used to centrally control the various components and stages of the main refrigeration circuit 10a in the manner described above. Moreover, the controller unit 15 may also control the hybrid heating system 20, though the hybrid heating system 20 may have its own controller unit as a possibility, with processor(s) 20a (FIG. 2) and a non-transitory computer-readable memory 20b that may be communicatively coupled to the processing unit and may have computer-readable program instructions executable by the processing unit for operating the hybrid heating system 20 in the manner described herein. The controller unit 15 has a processor with user interfaces, and may receive data from various sensors located at different locations in the refrigeration system 10 and in the environment of the refrigeration system 10, e.g., temperature and pressure sensors, etc. The controller unit 15 may also communicate with the components of the refrigeration system 10, to turn them on and off, and to adjust their operating parameters. This may include the operation of valves (e.g., solenoid valves) located throughout the refrigeration system 10. The controller unit 15 may also be in communication with user applications that can seek operator guidance remotely. For example, a user device may be in wireless communication with the controller unit 15, for instance by cellular network and/or internet, etc. Although not shown, the controller unit 15 receives operational data from various sensors in the refrigeration system 10, or associated with the refrigeration system 10, such as indoor and outdoor temperature sensors (e.g., thermometers, thermocouples). The controller unit 15 may also have access to data such as real-time energy cost, weather forecast, etc.

The controller unit 15 is configured to operate the refrigeration system 10 in a standard mode of operation of the main refrigeration circuit 10a. The standard mode of operation has the sequence of the compression stage 11, the condensing/reclaim stage 12 (or equivalent), the expansion stage 13 (or equivalent) and the evaporation stage 14, as explained above. For simplicity, the operation of the refrigeration system 10 as controlled by the controller unit 15 is explained with respect to the use of such a refrigeration system to refrigerate one or more ice sheets in an arena or like skating facility. However, similar principles of operation may be applied to other types of facilities, such as industrial refrigeration systems, supermarkets, etc.

Still referring to FIG. 1, the hybrid heating system 20 is shown being positioned downstream of the compression stage 11, for at least some of the refrigerant at the exit of the compression stage 11 to optionally be directed to the hybrid heating system 20. In a variant, the hybrid heating system 20 may optionally receive refrigerant from a downstream compressor if compressors are in cascaded arrangement.

In addition to the fluid connection to the compression stage 11, the hybrid heating system 20 may have the potable water tank 30 in a heat exchange relation with other heat sources, shown as heat source 1, heat source 2, and heat source n. Therefore, the potable water in the potable water tank 30 may selectively be heated by three or more different heat sources. The potable water tank(s) 30 is(are) connected to a potable water network, that may supply potable hot water to any demand, such as washrooms, showers, kitchen, process, etc. The hot water demand may depend on the facilities in which the refrigeration system 10 and/or the hybrid heating system 20 is operated. One or more potable hot water tanks 30 may be present in the arrangement of the refrigeration system 10, whereby the potable hot water tank 30 is labeled as n, wherein n = 1, 2, 3,… The potable water tank(s) 30 may or may not be part of the hybrid heating system 20. More particularly, the hybrid heating system 20 may be retrofitted into a refrigeration system 10 having potable water tanks 30, and may be sold separately from the potable water tank(s) 30. The opposite is also possible, i.e., the hybrid heating system 20 may include one or more potable water tanks 30.

Referring to FIG. 2, the hybrid heating system 20 is shown in greater details, along with one of the potable water tank 30. The potable water tank 30 may be of the type having an exterior jacket 30a in which a heat-exchanger conduit (pipe, serpentine, coil) is wrapped around the main water reservoir of the potable water tank 30. For instance, the potable water tank 30 may be a Mueller® jacketed tank, as a possibility among others. Accordingly, a refrigerant or coolant may circulate in the conduit. For example, the heat-exchanger conduit is shown as being 11a, and receives refrigerant exiting from the compression stage 11 (FIG. 1). In a variant, the refrigerant or coolant on the conduit 11a is in heat exchange relation with the water in the main reservoir of the potable water tank 30, by way of conduction. In another variant, the conduit 11a is wrapped against the wall of the main water reservoir of the potable water tank 30, such that the water in the reservoir and the refrigerant or coolant and separated by two partitions, i.e., the wall of the main water reservoir and the wall of the conduit. In a variant, the conduit 11a may be defined by the wall of the main water reservoir, such that a single partition could be present between the refrigerant/coolant and the water. However, for safety reasons, the presence of two partitions may be favored. The conduit 11a may also penetrate into the potable water tank 30 as another possibility.

A valve 11b and a bypass line 11c may be present, in order to control the amount of refrigerant/coolant that is sent to the potable water tank(s) 30. In a variant, it is possible for the valve 11b to be operated to completely stop the feed of refrigerant/coolant to the potable water tank(s) 30. The valve 11b may for example be a three-way solenoid valve, as an example among other types that can be used. For example, as an alternative, a system of valves could also be used. Though not shown, other hardware components may be present such as other valves (e.g., check valve), sensors, filters, etc, in the network of pipes featuring the conduit and bypass line 11c. If two or more potable water tanks 30 are present, they may be in parallel, in series.

The conduit 11a may be part of a desuperheater circuit, in a variant that depends on the type of refrigerant used in the main refrigeration circuit 10a. For example, if ammonia or HFCs are used, the conduit 11a may be used to desuperheat the superheated refrigerant at the exit of the compression stage 11. Alternatively, the conduit 11a may be part of a gas cooling circuit, if the refrigerant is CO₂ in a supercritical state.

Thus, the conduit 11a allows selective waste heat recovery off of the refrigerant circuit 10a optionally utilizing a desuperheater heat exchanger, in an embodiment. For sanitary reasons, the potable water tank(s) 30 may optionally include a tank that has an integral double walled heat exchanger, but could potentially be a separate heat exchanger, or could be done with two heat exchangers, with a refrigerant to an intermediate water circuit heat exchanger in combination with an intermediate water-to-potable-water heat exchanger. Other options are possible.

In another variant, the conduit 11a may be arranged for waste heat to be boosted in temperature utilizing a refrigerant heat pump circuit to maximize the available waste heat by allowing for full condensing, instead of relying solely on desuperheating or gas cooling the refrigerant. Stated differently, in some instances, the condensing of the condensing stage 12 may be done entirely using the water on the potable water tank(s) 30.

In FIG. 1, there are illustrated heat sources 1, 2, n. One of the heat sources is the feed of refrigerant/coolant from the compression stage 11 as explained about. Another heat source is illustrated as being a first type of solar heating system, i.e., a solar thermal system 21. The solar thermal system 21 includes one or more solar thermal panels 21a. The solar thermal panels 21a are configured to receive solar heat, and capture the heat. For example, a fluid coolant is in the solar thermal panel 21a, and absorb the heat directly from being heated by solar energy. The solar thermal panel 21a may be selected to have a high emissivity, to capture heat and transmit it to the fluid coolant in the solar thermal system 21. The solar thermal system 21 may further include a network of piping 21b for the fluid coolant to circulate to the potable water tank 30, for the fluid coolant to release captured heat to the potable water in the potable water tank 30. The network 21b may therefore include a coil(s) 21c in the potable water tank 30, or on a surface thereof (in similar fashion to the heat-exchanger conduit 11a). The fluid coolant may then be cycled back to the solar thermal panel 21a. A pump 21d, or other motive source may optionally be present. In a variant, the solar thermal system 21 may rely on a thermosiphon effect for the fluid coolant to cycle between the solar thermal panel 21a and the coil 21c. Thus the solar thermal system 21 provides heat to a heating coil 21c in the tank 30, but may alternatively use a separate external heat exchanger to provide an additional degree of separation between the fluid coolant in the solar thermal panel 21a and the potable hot water.

In a variant featuring multiple potable water tanks 30, there may be multiple solar thermal systems 21. However, it is also possible to have a single solar thermal system 21 with multiple coils 21c, e.g., one for each potable water tank 30. The multiple coils 21c may be in series or in parallel. The network of piping 21b may have different paths, to control the feed of fluid coolant to the various potable water tanks 30 in a multi-tank configuration, based on the temperature in each of the potable water tanks 30. Though not shown, other hardware components may be present such as other valves (e.g., check valve), sensors, filters, etc, in the network of piping 21b.

Still referring to FIG. 2, another heat source is illustrated as being a second type of solar heating system, i.e., a solar photovolatic system 22. The solar photovoltaic system 22 includes one or more solar photovoltaic panels 22a or surface(s) coated with a photovoltaic paint or coating. The photovoltaic panels 22a are configured to receive solar light, and convert the light in electric power. The solar photovoltaic system 22 may further include a circuit 22b for the electricity to be directed to a battery 22c. The battery 22c may store electric power. In a variant, the battery 22c is a battery system, that may include an inverter, and that may be connected to the electrical system of the building (e.g., grid). The solar photovoltaic system 22 may further include an electric heater(s) 22d, that is in heat exchange relation with the water in the potable water tank 30, for the electric heater 22d to heat the potable water in the potable water tank 30. The electric heater 22d may therefore include a coil(s) in the potable water tank 30, or on a surface thereof (in similar fashion to the heat-exchanger conduit 11a).

In a variant featuring multiple potable water tanks 30, there may be multiple solar photovoltaic systems 22. It is also possible to have a single solar photovoltaic system 22 with multiple batteries 22c and/or electric heaters 22d, e.g., one for each potable water tank 30. The multiple electric heaters 22d may be in series or in parallel. The circuit 22b may have different connections, to control the powering of the multiple electric heaters 22d to the various potable water tanks 30 in a multi-tank configuration, based on the temperature in each of the potable water tanks 30. Though not shown, other hardware components may be present such as sensors, etc, in the circuit 22b.

According to a mode of operation, the electric power generated by the solar photovoltaic system 22 may supply the electric heater(s) 22d directly. In another mode of operation, the electric power generated by the solar photovoltaic system 22 may be used to charge the battery or batteries 22c. In yet another mode of operation, the electric power generated by the solar photovoltaic system 22 may be fed to the grid or to the electrical system of the building. In yet another mode of operation, the electrical system of the building(s) may power the electric heater(s) 22d without using battery power and/or electric power from the solar photovoltaic system 22. In such a mode of operation, the combination of electric heater(s) 22d and electrical system of the building(s) may be another one of the heat sources shown in FIG. 1 as 1, 2, n. Therefore, the arrangement of the hybrid heating system 20 in FIG. 2 may have four different heat sources, i.e., the refrigerant of the compression stage 11, the solar thermal system 21, the solar photovoltaic system 22 and the electrical system of the building.

In a variant, the hybrid heating system 20 uses hybrid solar panels (e.g., PF3S panels), that have both the capacities to capture solar heat for the solar thermal system 21, and to convert solar energy to electricity in the solar photovoltaic system 22.

In another variant, the battery or batteries 22c may be used to power the pump 21d or like motive source of the solar thermal system 21, though this is optional. The pump 21d, if present, may also be powered by the electrical system of the building. However, the use of the battery power may increase the reliance of the hybrid heating system 20 on environmentally friendly energy sources, in a variant. Thus, the solar photovoltaic system 22 may be used to primarily supply electric power to the electric heater(s) 22d, but may also have the potential to operate the pump 21d as well as to store and provide excess electricity back to the building. This could be an advantage to a customer when electrical rates are higher and/or to potentially reduce peak electrical demand charges.

Another heat source from the heat sources 1, 2, n of FIG. 1 may include a combustion system or like burner. The combustion system may utilize for example a low carbon intensity biofuel obtained from green sources, or if optionally fossil fuel. This fuel-based backup heating could potentially be integrated into a single tank, or supplemental tanks in series.

Another heat source from the heat sources 1, 2, n of FIG. 1 may include a separate standalone air-to-water heat pump system may be utilized to provide supplemental heat in parallel with, or instead of the solar thermal system 21.

Each of these heating sources are used with a master control system that optimizes for the lowest total energy cost and/or the lowest carbon emissions. For example, the master control system may have access to current electricity price, and to electricity tariffs as a function of the hour of the day, time period of the year (e.g., winter or summer), electricity sale price if electricity can be supplied to the grid by the hybrid heating system 20, gas or oil price (e.g., if one of the heat sources n is oil or gas). The master control system may be part of the controller unit 15 (FIG. 1), or may be with the processor unit 20a of the hybrid heating system 20, if present and distinct from the controller unit 15.

The hybrid heating system 20 may optimize to the lowest operating cost, lowest carbon emissions, and/or to some balance between these depending on calculated factors and/or user input priority. There may be different factors that come into play when selecting how to operate the hybrid heating system 20. The hybrid heating system 20 may determine the status of heating load and prioritize heating source(s) to utilize based on operating conditions. The hybrid heating system 20 may determine if multiple heating sources 21 and associated heating modes are required to meet the heating load to then determine and prioritize which of these heating modes are necessary to use simultaneously.

If the solar thermal system 21 is present and can be utilized to heat the water either entirely or in conjunction with heat reclaim from the main refrigeration circuit 10a, and it is determined that it is the most effective means, then the solar photovoltaic system 22 may store electrical power in the battery 22c (if present) and/or provide excess electrical power to the building. Excess electrical power may be provided to the building of the charge of the battery 22c is sufficiently high.

If the solar photovoltaic system 22 is present and electricity rates vary by time of day or by demand (e.g., a tariff of staggered rates per total wattage), then the controller unit of the hybrid heating system 20 may prioritize when to utilize the solar photovoltaic system 22 for electric heating in the potable water tank 30, when to drive the pump 21d, when to store electrical power using the battery 22c (if present), and/or when to utilize the power generated from the solar photovoltaic system 22 of from the battery 22c directly in the building.

If it is determined that the combined heating capacity of the main refrigeration circuit 10a, the solar thermal system 21, and the solar photovoltaic system 22 (if all present) will be insufficient, then the hybrid heating system 20 may utilize either electric power from the battery(ies) 22c or from the electrical system of building. The hybrid heating system 20 may potentially generate supplemental heat using combustion, such as by using biogas (if available), or fossil fuel as a last option.

The controller unit of the hybrid heating system 20 may monitor the operation of the refrigerant plant/cooling load and predict whether sufficient heat will be available to provide all necessary heat, or if one or more supplemental heat sources may be required to contribute. The controller unit of the hybrid heating system 20 may also take into account the carbon intensity of energy from the electrical utility grid, from biogas, or from fossil fuel utilized for supplemental heating to determine heating priorities. The controller unit of the hybrid heating system 20 may take into account the cost of energy for each heating mode. In order to do so, energy rates may either be entered manually or updated automatically based on real time pricing, as the controller unit of the hybrid heating system 20. The controller unit may thus operate the heating system using one or more parameters associated with energy characterization, with the one or more parameters being: availability (e.g., daylight for sun), cost, carbon footprint, energy density, weather forecast, anticipated heating demand, anticipated cooling demand, refrigeration system operating parameters, peak demand.

If the main refrigeration circuit 10a has other heat recovery demands, the hybrid heating system 20 may be able to let the heat exchanger 11a heat be available for these other heating functions, and the controller unit of the hybrid heating system 20 may calculate that the potable water tank 30 can be heated solely by the other heat sources, such as the solar thermal system 21 and/or the solar photovoltaic system 22. The heat exchanger 11a could be bypassed to conserve the available refrigerant waste heat for other uses. Likewise, the hybrid heating system 20 may take into account the refrigerant energy penalty that may occur due to the pressure drop at the heat exchanger 11a, if the solar thermal system 21 and/or the solar photovoltaic system 22 are available to provide heat, as they may cost less and/or may be less carbon intensive.

During operation of the main refrigeration circuit 10a, refrigerant or coolant is fed to the evaporation stage 14 so as to capture heat of the ice sheet, or other cooling load. Stated differently, the main refrigeration circuit 10a is operated to meet the cooling load, the cooling load being the amount of energy required to keep the ice sheet(s) at a desired condition. Heat reclaim may occur in the condensing/reclaim stage 12. However, in some given operation conditions, such as in winter time, the cooling load may be smaller than in summer operation, for different reasons, whereby the other heat sources may be favoured over the heat exchanger 11a.

For example, if the outdoor temperature is colder, the cooling load may be smaller due to the fact that less heat is lost by the ice sheet (or like refrigeration load) to ambient. Accordingly, the reclaim that may occur in the condensing/reclaiming stage 12 may be qualified as low-grade heat. Depending on the refrigerant, low-grade heat may be defined as condensing refrigerant at the condensing/reclaiming stage 12 being at a typical temperature ranging from 15-40 degrees Celsius, though the temperature range of low-grade heat could be different. This low-grade heat may not be sufficient for some heating loads, such as heating a facility, heating water. For example, in the case of a skating facility, the demand for hot water may be large, notably because of restrooms that require hot water, such as for showers. The reclaim contribution of the desuperheating and condensing/reclaim stage 12 may be insufficient to raise the water temperature sufficiently for restrooms/showers. Therefore, in such scenarios, the other sources of heat may be used in order to heat up water, and/or a combination of the various heat sources.

The main refrigeration system 10a of FIG. 1 may be configured to generate high-grade heat, namely heat that is at a typical temperature ranging from 50 to 80 degrees Celsius (though the temperature range of high-grade heat could be different), or a temperature of at least 50 degrees Celsius, and hence contribute substantially to the heating demand of the hybrid heating system 20. The controller unit 15 is therefore configured to monitor the operation of the refrigeration system 10 and that of a heating load demand, and trigger a high-grade heat reclaim mode when necessary.

In a variant, the heating system 20 may generally be described as being used with a potable water tank in conjunction with a main refrigeration circuit, the heating system comprising: a heat exchanger configured to be in a heat exchange relation (whether directly or indirectly via an intermediate coolant) with potable water in the potable water tank, the heat exchanger configured to receive therein a refrigerant or coolant in condition for heating the potable water as the refrigerant or coolant is associated with an exit of at least one compressor of the main refrigeration circuit; at least one solar heating system configured for generating heat from solar power, the at least one heating system using the heat generated from solar power to heat the potable water in the potable water tank; and a controller unit configured for operating the heating system as a function of at least one parameter associated with energy characterization.

In a variant, the refrigeration system 10 may generally be described as being for heating potable hot water, and may have: a processing unit; and a non-transitory computer-readable memory communicatively coupled to the processing unit and comprising computer-readable program instructions executable by the processing unit for: operating a main refrigeration circuit as a function of a cooling load of an evaporation stage, the main refrigeration circuit using a refrigerant; harvesting energy from solar power; monitoring at least one parameter associated with energy characterization; and as a function of a heating demand of potable hot water tank, selectively: directing at least a portion of said refrigerant from a compressor of the main refrigeration circuit to a heating system for heating potable water in the potable hot water tank, and generating heat from the solar power to heat potable water in the potable hot water tank. The computer-readable program instructions are for selectively using the solar power to generate electricity and storing the electricity in a battery.

1. A heating system for potable water tank in conjunction with a main refrigeration circuit, the heating system comprising:
a heat exchanger configured to be in a heat exchange relation with potable water in the potable water tank, the heat exchanger configured to receive therein a refrigerant or coolant in condition for heating the potable water as the refrigerant or coolant is associated with an exit of at least one compressor of the main refrigeration circuit;
at least one solar heating system configured for generating heat from solar power, the at least one solar heating system using the heat generated from solar power to heat the potable water in the potable water tank; and
a controller unit configured for operating the heating system as a function of at least one parameter associated with energy characterization.

2. The heating system according to claim 1, wherein the at least one solar heating system is a solar thermal system configured to generate heat from solar power and/or a solar photovoltaic system configured to convert solar power into electric power.

3. The heating system according to claim 2, wherein the solar thermal system includes a network of piping configured to cycle a coolant between at least one solar thermal panel and a coil in heat exchange relation with the potable water of the potable water tank.

4. The heating system according to claim 3, wherein the network of piping includes a pump.

5. The heating system according to claim 4, wherein the solar heating system includes both the solar thermal system and the solar photovoltaic system, and wherein the pump is operated by electric power generated by the solar photovoltaic system.

6. The heating system according to claim 2, including both the solar thermal system and the solar photovoltaic system, and wherein the solar photovoltaic system includes a circuit featuring a battery to store electric power generated by at least one photovoltaic panel of the solar photovoltaic system.

7. The heating system according to claim 2, including both the solar thermal system and the solar photovoltaic system, and including at least one hybrid solar panel configured to generate heat and electric power.

8. The heating system according to claim 2, wherein the solar thermal system includes an electric heater, and wherein the electric heater is configured to be selectively powered by the grid.

9. The heating system according to claim 1, wherein the heat exchanger is a desuperheater heat exchanger.

10. The heating system according to claim 1, wherein the heat exchanger is a gas cooling heat exchanger.

11. The heating system according to claim 1, including the potable water tank.

12. The heating system according to claim 2, wherein the solar thermal system includes an electric heater, and wherein the electric heater is configured to be selectively powered by the grid.

13. The heating system according to claim 2, including at least one other system for heating the water.

14. The heating system according to claim 13, wherein the other system includes an electric coil configured to be powered by the grid.

15. The heating system according to claim 13, wherein the other system includes a fossil fuel heated coil configured to provide heat by fossil fuel combustion.

16. The heating system according to claim 13, wherein the other system includes a heat pump system configured to heat a refrigerant of the main refrigeration system between the at least one compressor of the main refrigeration circuit and the heat exchanger of the heating system.

17. A refrigeration system comprising:
a main refrigeration circuit in which a refrigerant circulates at least between a compression stage in which the refrigerant is compressed, a cooling stage in which the compressed refrigerant releases heat, and a refrigeration stage in which the refrigerant absorbs heat to then be directed at least partially to the compression stage; and
the heating system according to claim 1.

18. The refrigeration system according to claim 17, wherein the refrigeration system is a supermarket refrigeration system or an ice-rink refrigeration system.

19. A system for heating potable hot water, comprising:
a processing unit; and
a non-transitory computer-readable memory communicatively coupled to the processing unit and comprising computer-readable program instructions executable by the processing unit for:
operating a main refrigeration circuit as a function of a cooling load of an evaporation stage, the main refrigeration circuit using a refrigerant;
harvesting energy from solar power;
monitoring at least one parameter associated with energy characterization; and
as a function of a heating demand of potable hot water tank, selectively:
directing at least a portion of said refrigerant from a compressor of the main refrigeration circuit to a heating system for heating potable water in the potable hot water tank, and
generating heat from the solar power to heat potable water in the potable hot water tank.

20. The system according to claim 19, wherein the computer-readable program instructions executable by the processing unit are for, as a function of the heating demand of potable hot water tank, selectively using the solar power to generate electricity and storing the electricity in a battery.
